(19) United States
(12) Patent Application Publication
(10) Pub. No.: US 2007/0219079 A1
(43) Pub. Date: Sep. 20, 2007

(54) Electrical conductive roller

(75) Inventors: Hidehiro Tanaka, Tokyo (JP); Hideo Tanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/584,497

(22) Filed: Oct. 23, 2006

(30) Foreign Application Priority Data
Oct. 25, 2005 (JP) 2005-310,208

(51) Int. Cl. F16C 13/00; B25F 5/02

(52) U.S. Cl. 492/49; 492/53

(57) ABSTRACT

There is provided an electrical conductive roller having a roller body made from a resin with a light weight and a high accuracy, in which is the roller body is constituted with plural hollow members connected to each other in the longitudinal direction and is provided with a bonding means for keeping the connection of the hollow members even under a release of a compression force in the longitudinal direction.

### BACKGROUND OF THE INVENTION

1. Field of the Invention

This invention relates to an electrical conductive roller, and more particularly to an electrical conductive roller used as various roller members in an imaging apparatus such as a copying machine, a printer or the like.

2. Related Art

In the imaging apparatus such as copying machine, printer or the like are used various electrical conductive rollers having an electrical conductivity such as a transfer roller, an image developing roller, a toner feed roller, a charging roller, a cleaning roller, a middle transfer roller, a belt driving roller and so on at imaging steps.

As such an electrical conductive roller, there is proposed a roller wherein an electrical conductive elastomer layer is formed on an outer surface of a roller body acting as a shaft member and the roller body is constituted with a hollow pipe member made of an electrically conducting agent-containing resin for the purpose of reducing the weight of the electrical conductive roller (see, for example, JP-A-2004-150610).

However, the roller body disclosed in the above document has a structure that a single pipe member is existent between both ends in the longitudinal direction of the roller body. In the production of such a resin pipe member, there are considered a method of injection-molding a resin in a mold for a continuous pipe member and a method of machining a resin rod. The latter method is an unrealistic method because the enormous cost is required when it is applied to the mass production as in the electrical conductive roller. On the other hand, the former method is advantageous in view of the cost, but has a problem in the accuracy because it is difficult to finish the roller body to a desired uniform size in the longitudinal direction.

### SUMMARY OF THE INVENTION

It is an object of the invention to solve the aforementioned problems and to provide an electrical conductive roller provided with a light weight, high accuracy roller body.

According to the invention, there is the provision of an electrical conductive roller comprising a roller body mainly made from a resin material and an electrically conducting agent and an elastomer layer supported on an outer periphery of the roller body, in which the roller body is constructed with a plurality of hollow members connected to each other in a longitudinal direction thereof and is provided with a bonding means for keeping the connection of the hollow members even under a release of a compression force in the longitudinal direction.

In a preferable embodiment of the invention, the roller is provided with a shaft passing through the roller body in the longitudinal direction.

In another preferable embodiment of the invention, the roller has a crown form increasing a diameter from each end portion toward a central portion in the longitudinal direction thereof.

According to the invention, the roller body is constituted with the hollow members made of a resin, so that the weight of the electrical conductive roller can be reduced, Also, since the length of the hollow member is short, it is possible to uniformly prepare the hollow member in a high accuracy, so that the accuracy as the whole of the roller body can be made higher by connecting such hollow members to each other. Furthermore, the roller is provided with the bonding means for keeping the connection of the hollow members even under a release of a compression force in the longitudinal direction, so that the connection of the hollow members is not loosed in the assembling or the replacing for maintenance, and hence the assembling or maintenance operation can be made easy and the time required therefor can en shortened.

According to the first preferable embodiment, the roller body is provided with the shaft passing therethrough in the longitudinal direction, the rigidity of the roller can be improved to increase the strength against the bending.

According to the second preferable embodiment, the roller body is constructed so as to have such a crown form that the diameter is increased from each end portion in the longitudinal direction toward the central portion, so that even if the elastomer layer is formed at a constant thickness, the electrical conductive roller having a crown form that the diameter at the central portion is large can be produced easily. Since the electrical conductive roller has such a crown form, even if the roller is mounted onto the imaging apparatus and contacted, for example, with a photoconductive drum by pushing both end portions in the longitudinal direction thereof, a uniform contact pressure in the longitudinal direction can be obtained, which can prevent a trouble that if the electrical conductive roller is a flat cylindrical form, the central portion in the longitudinal direction is floating and the contact pressure becomes low at the center in the longitudinal direction.

### BRIEF DESCRIPTION OF THE DRAWINGS

The invention will be described with reference to the accompanying drawings, wherein:

FIG. 1 is a perspective view of an electrical conductive roller according to an embodiment of the invention;

FIG. 2 is a perspective view of a roller body in the electrical conductive roller of FIG. 1;

FIG. 3 is a section view of hollow members connected to each other through a first embodiment of the bonding means;

FIG. 4 is a section view of hollow members connected to each other through a second embodiment of the bonding means;

FIG. 5 is a section view of hollow members connected to each other through a third embodiment of the bonding means;

FIG. 6 is a section view of hollow members connected to each other through a fourth embodiment of the bonding means;

FIG. 7 is a section view of hollow members connected to each other through a fifth embodiment of the bonding means;

FIG. 8 is a side view of a roller body having various structures of end portions;

FIG. 9 is a perspective view of a modified embodiment of a form of a shaft portion, a hole portion for the shaft and a gear portion;

FIG. 10 is a perspective view of a modified embodiment of the roller body; and

FIG. 11 is a perspective view of another modified embodiment of the roller body.

### DETAILED DESCRIPTION OF THE INVENTION

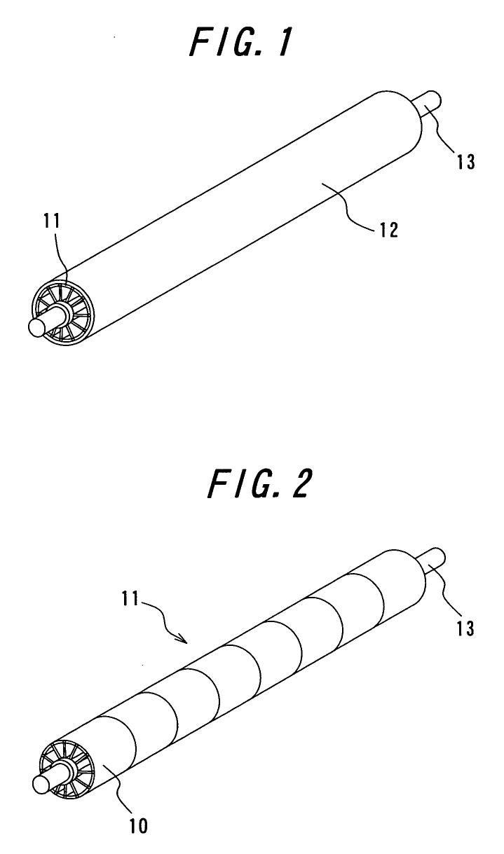

In FIG. 1 is shown a perspective view of an electrical conductive roller according to an embodiment of the invention. As shown in FIG. 1, the electrical conductive roller according to the invention comprises a roller body 11 and an elastomer layer 12 supported on an outer periphery thereof. In the invention, the roller body 11 is comprised of plural hollow members 10 connected to each other in the longitudinal direction thereof, in which the connection of these members is kept even at a state not subjected to external force.

In FIG. 2 is shown a construction of the electrical conductive roller (see FIG. 1) before the formation of an elastomer layer 12. The illustrated roller body 11 is comprised of, for example, eight members 10 connected to each other in the longitudinal direction. Since the roller body 11 is constructed with plural hollow members 10 divided in the longitudinal direction, the length of the member in the longitudinal direction becomes short as compared with the conventional metal pipe or single-piece resin product, and hence the working accuracy can be improved but also the working of each member becomes easy, which can contribute the improvement of the productivity.

The electrical conductive roller according to the invention is preferable to be provided with a shaft passing through the roller body 11 in the longitudinal direction as shown in the figures. By arranging the shaft 13 so as to pass through the roller body 11 or the electrical conductive roller in the longitudinal direction can be improved the rigidity of the roller to enhance the strength against the bending.

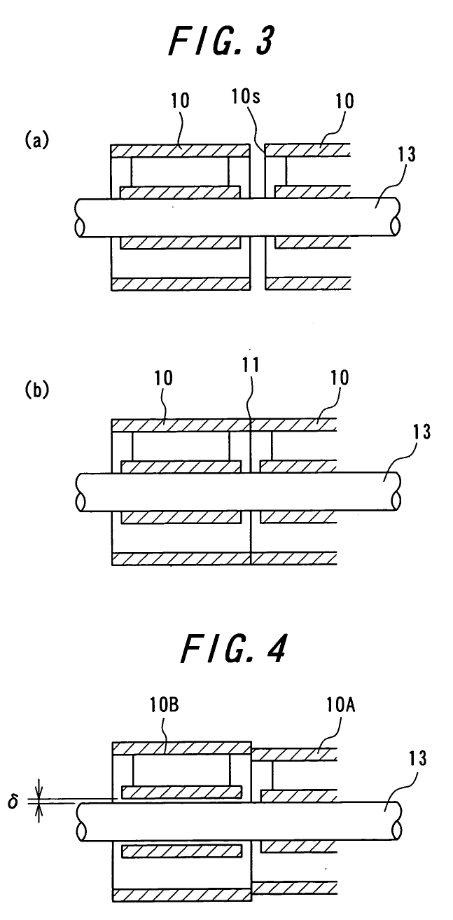

As a bonding means for keeping the connection of the hollow members 10 even under a release of a compression force in the longitudinal direction can be exemplified the followings. A first embodiment of the bonding means is a bonding means through an adhesion or a welding. In case of the adhesion, as shown in a section view of FIG. 3(a), an adhesive is applied to an end face 10a in one or both of the hollow members to be connected or a hot melt treatment is applied to the end face or a double-coated tape is attached to the end face and thereafter the members 10 are connected to each other by pushing as shown in FIG. 3(b). In case of the welding between the members 10, a laser or a super-sonic wave is applied to the end face 10s at a state shown in FIG. 3(a) to fuse the surface of the end face and there after the end faces 10s of the members are connected to each other by pushing as shown in FIG. 3(b). Also, as a means for simultaneously conducting the fusing and the pushing is a spin weld for the fusion of the end face, in which the end faces to be connected are opposed and pressed to each other and one of the members 10 is rotated at this state, during which the end faces are fused by heat generated through friction to connect them to each other.

A second embodiment of the bonding means is a means for indirectly connecting the hollow members 10 to each other by fixing the each hollow member 10 to the shaft 13, in which the connection of the hollow members 10 can be kept even under the release of the compression force in the longitudinal direction likewise the first embodiment. FIG. 4 is a section view of the roller body according to the second embodiment. In this case, one hollow member 10A is at a state of fixing to the shaft 13, while the other hollow member 10B is at a state that a gap δ is formed between an inner peripheral face of the hollow member 10B and an outer peripheral face of the shaft 13 by heating the member 10B at a temperature above 150° C. or both of the member 10B and the shaft 13 are not fixed to each other. Thereafter, the temperature of the member 10B is descended to not higher than 120° C. while keeping the position of the member 10B in the longitudinal direction, whereby the member 10B is shrinkage-fitted onto the shaft 13 to conduct the fixation between the member 10B and the shaft 13.

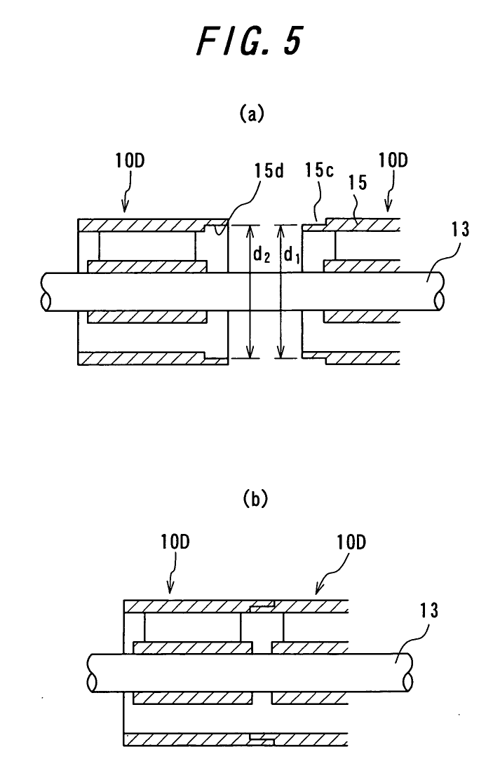

A third embodiment of the bonding means is a means for connecting the adjoining hollow members 10D by press fitting. As shown in FIG. 5(a), step peripheral faces 15c, 15d are formed at end portions of outer cylinders of the members 10D, in which one end portion is convex at its radially inside and the other end portion is convex at its radially outside and a diameter d₁ of the step peripheral face 15c as an outer peripheral face is made larger than a diameter d₂ of the other step peripheral face 15d as an inner peripheral face, and then these hollow members 10D can be fixed to each other by press fitting as shown in FIG. 5(b).

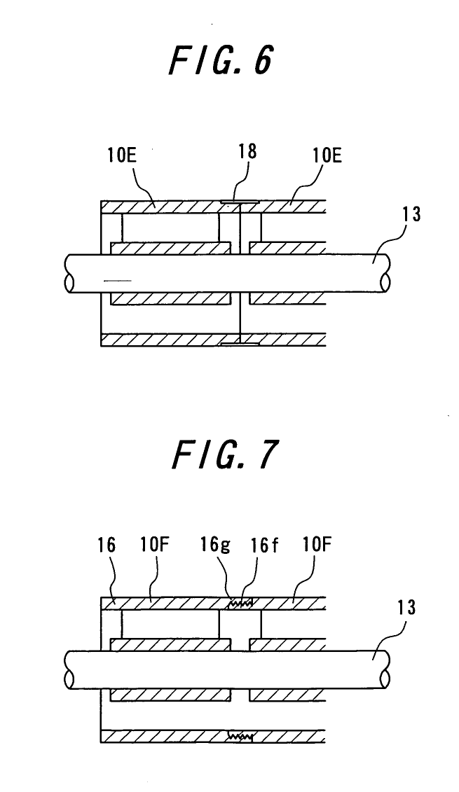

In a fourth embodiment of the bonding means, as shown in FIG. 6, end faces of the hollow members 10E are contacted with each other and an adhesive tape 18 is wound around the outer peripheral face including the joint part thereof, whereby the hollow members 10E are connected to each other through the adhesive tape 18.

In FIG. 7 is shown a section view of the roller body using a fifth embodiment of the bonding means, in which the adjoining hollow members 10F are connected to each other through screwing. In this case, the outer cylinder 16 of the member 10F is provided at its one end with a male screw portion 16f and at its other end with a female screw portion 16g, and the members 10F having such a structure are screwed to each other.

As a resin material used in the hollow member 10 can be properly selected general-purpose resins and engineering plastics as far as they have a proper strength and can be shaped by injection molding or the like, which are not particularly limited. As the engineering plastic are mentioned, for example, polyacetal, polyamide resin (polyamide-6, polyamide-6,6, polyamide-12, polyamide-4,6, polyamide-6,10, polyamide-6,12, polyamide-11, polyamide MXD6 (polyamide obtained from methaxylylene diamine and adipic acid), or the like), polybutylene terephthalate, polyphenylene oxide, polyphenylene ether, polyphenylene sulfide, polyether sulfone, polycarbonate, polyimide, polyamideimide, polyether imide, polysulfone, polyether ether ketone, polyethylene terephthalate, polyallylate, liquid crystal polymer, polytetrafluoroethylene and the like. As the general-purpose resin are mentioned polypropylene, acrylonitrile-butadiene-styrene (ABS) resin, polystyrene, polyethylene and the like. Also, melamine resin, phenolic resin, silicone resin and the like may be used. These resins may be used alone or in a combination of two or more.

Among them, the engineering plastics are particularly preferable. Further, polyacetal, polyamide resin, polybutylene terephthalate, polyphenylene ether, polyphenylene sulfide, polycarbonate and the like are preferable in a point that they are thermoplastic and are excellent in the shapability and the mechanical strength. Particularly, polyamide-6,6, polyamide MXD6, polyamide-6,12, polybutylene terephthalate or a mixture thereof is preferable. Moreover, it is allowed to use thermosetting resins, but it is preferable to use thermoplastic resins considering the recycling property.

As the electrically conducting agent, it is possible to use various ones as far as they can be uniformly dispersed into the resin material, but it is preferable to use a powdery conducting agent such as carbon black powder, graphite powder, carbon fiber, powder of a metal such as aluminum, copper, nickel or the like, powder of a metal oxide such as tin oxide, titanium oxide, zinc oxide or the like, electrically conductive glass powder, or the like. They may be used alone or in a combination of two or more. The amount of the electrically conducting agent compounded is selected so as to provide a proper resistance value in accordance with the application or state of the electrical conductive roller to be targeted and is not particularly limited, but it is preferable to be usually 5-40 wt %, particularly 5-20 wt % per the whole of the material in the hollow member 10.

The volume resistivity of the hollow member 10 is properly set in accordance with the application or the like of the roller, but it is usually 1×10⁰−1×10¹² Ω·cm, preferably 1×10⁰−1×10⁶ Ω·cm, more preferably 1×10⁰−1×10³ Ω·cm.

The material of the hollow member 10 may be compounded with various electrically conductive or non-conductive fibrous substances, whisker, ferrite and the like for the purpose of the reinforcement, increase in weight and the like, if necessary. As the fibrous substance are mentioned fibers such as carbon fiber, glass fiber and the like. As the whisker may be mentioned an inorganic whisker of potassium titanate or the like. They may be used alone or in a combination of two or more. The compounded amount may be properly selected in accordance with the length and diameter of the fibrous substance or whisker used, kind of the resin material as a main component, strength of the target roller and the like, but it is usually 5-70 wt %, particularly 10-20 wt % per the whole of the material.

As the shaft 13 may be used, for example, resulphurized carbon steel, aluminum, stainless steel or the like subjected to nickel plating, zinc plating or the like.

Since the roller body 11 constitutes a core portion of the electrical conductive roller, it is required to have a strength sufficient to stably develop good performances as a roller. For this end, the roller body is preferable to have a strength of not less than 80 MPa, particularly not less than 130 MPa as a bending strength according to JIS K7171, which can surely develop the good performances over a long time of period. Moreover, the upper limit of the bending strength is not particularly limited, but is usually about 500 MPa.

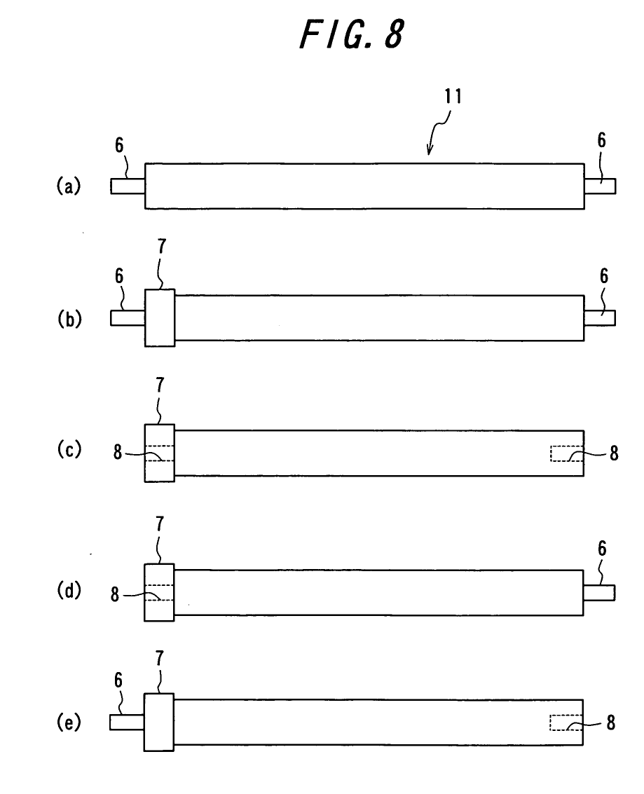

FIG. 8 is a side view of a roller body having various structures of its end portions, in which FIGS. 8(a) and 8(b) show an example that both end portions are constituted with a shaft portion 6, and FIG. 8(c) shows an example that both end portions are constituted with a hole portion 8 for the shaft, and FIGS. 8(d) and 8(e) show an example that one of both end portions is constituted with a shaft portion 6 and the other thereof is constituted with a hole portion 8 for the shaft, respectively. Also, FIGS. 8(b)-8(e) show an example that a gear portion 7 is disposed on one end portion, respectively. Further, the gear portion 7 may be disposed on both end portions, in which the roller body 10 plays a role of conducting power transmission. In any case, the gear portion 7 may be integrally united with a cylindrical portion or a columnar portion.

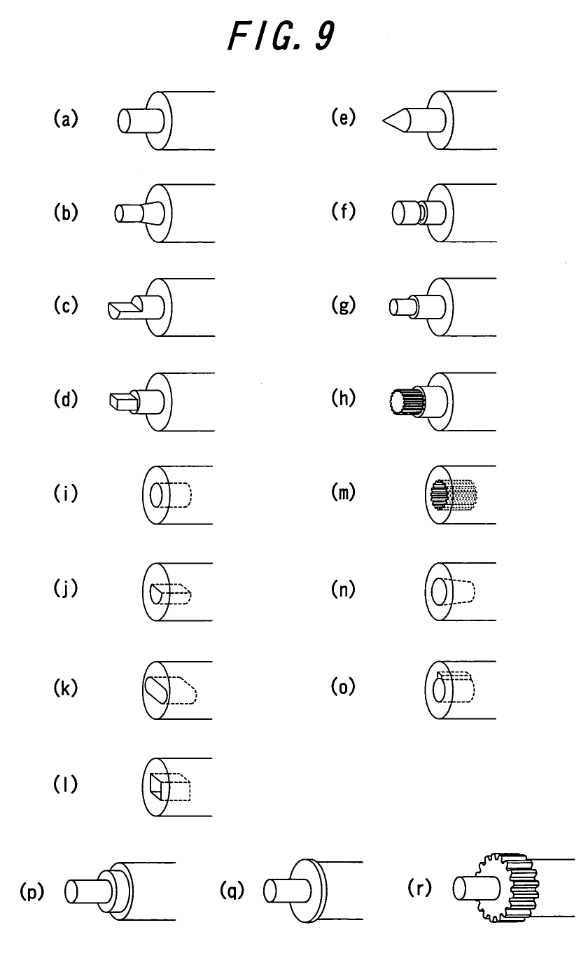

The shaft portion 6 of the roller body 11 shown in FIG. 8 is a cylindrical column of a simplest form as shown in a perspective view of FIG. 9(a). Also, there can be used a column having a tapered portion as shown in FIG. 9(b), a column subjected to D-cut working as shown in FIG. 9(c), a column having a prism as shown in FIG. 9(d), a column having a steeple end portion as shown in FIG. 9(e), a column having an annular groove as shown in FIG. 9(f), a column having a shouldered portion as shown in FIG. 9(g), a column having a spline or outer teeth portion for gear on its outer peripheral face as shown in FIG. 9(h), and so on. As the hole portion 8 for the shaft, use may be made of a simple round hole form as shown in a perspective view of FIG. 9(i), a D-type section form as shown in FIG. 9(j), an oval section form as shown in FIG. 9(k), a square hole form as shown in FIG. 9(l), a spline or an inner teeth portion for gear formed in an inner peripheral face as shown in FIG. 9(m), a tapered hole portion as shown in FIG. 9(n), a round hole provided with a key groove as shown in FIG. 9(o), and so on.

Further, there may be used an end portion having a shouldered part at its end as shown in FIG. 9(p), an end portion having a flanged part at its end as shown in FIG. 9(q), an end portion having a geared part at its end as shown in FIG. 9(r), and so on.

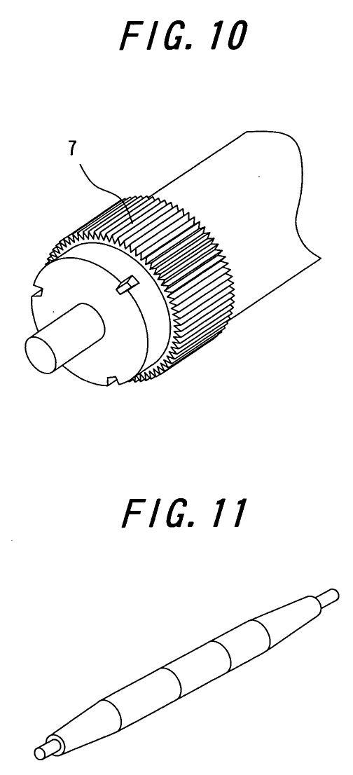

In the invention, the form of the roller body 11 itself is not particularly limited and may properly take a desired form. For example, a shaft portion of a proper form such as a geared portion 7 (see FIG. 10), a D-cut form or the like is formed in a member corresponding to the end portion of the roller body in the longitudinal direction, or a member composed of only a geared portion is joined to the end portion after the formation of the roller body, whereby such a functional part can be given to the end portion of the roller body 11 in the longitudinal direction, if necessary. Thus, it is not required to separately use the shaft or subject the shaft to a complicated working, and also the centering of the functional part becomes easy.

Also, the outer profile of the roller body 11 is not limited to the straight cylindrical form extending in the longitudinal direction as shown in FIG. 2 and the like, and may take a crown form increasing the diameter from each end portion toward the central portion in the longitudinal direction as shown in FIG. 11. In case of the conventional metal pipe or single-piece resin product, the outer profile of the roller body is generally a straight columnar form, and it is difficult to cope with the crown form in which the diameter at the central portions is larger than that at the end portion, and it is required to conduct the shaping with the use of an expensive mold or the control of thickness in the polishing of the elastomer layer 3, the application of the resin layer 4 (dipping or the like) and the like. In the embodiment of the invention, the hollow members 10 are connected to each other in the longitudinal direction, so that the degree of difficulty in the working of each of the members is low and the working to the crown form or the like is easy and it is possible to sufficiently ensure the working accuracy. Moreover, the number of the members constituting the roller body 11 is not particularly limited, and may be properly determined from a viewpoint of the strength and cost.

The electrical conductive roller according to the invention can be manufactured by connecting a plurality of the hollow members 10 to each other in the longitudinal direction to form the roller body 11 and then forming the elastomer layer 12 on the outer periphery thereof.

As a material of the elastomer layer 12 can be used an elastic body having an electrically conductivity formed by adding an electrically conducting agent to an elastomer or a foamed body thereof. The elastomer to be used is not particularly limited, but includes nitrile rubber, ethylene-propylene rubber, styrene-butadiene rubber, butadiene rubber, isoprene rubber, natural rubber, silicone rubber, urethane rubber, acryl rubber, chloroprene rubber, butyl rubber, epichlorohydrin rubber and the like. They may be used alone or in a combination of two or more. Among them, ethylene-propylene rubber, butadiene rubber, silicone rubber and urethane rubber are preferable, and also a blend with the other rubber material rubber thereof is suitable. In the invention, it is particularly preferable to use a resin having a urethane bond.

Also, the above elastomer may be used as a foamed body by chemically blowing with a foaming agent, or by mechanically blowing air as in the conventional polyurethane foam. In the invention, there may be used a so-called RIM molding method wherein two monomer components as a starting material constituting the elastomer layer 12 are mixedly injected into a cylindrical mold to conduct polymerization at a step of integrally uniting the roller body 11 with the elastomer layer 12. In this case, the formation of the elastomer layer 12 can be carried out for a time required from the pouring of the starting material to the detaching from the mold of about 60 seconds, so that it is possible to largely reduce the production cost.

As the electrically conducting agent added to the elastomer layer 12 may be used the same electrically conducting agent as mentioned on the roller body 11.

In the electrical conductive roller according to the invention, the surface roughness, hardness, electrical conductivity and the like of the roller can be properly adjusted by the elastomer layer 12 formed on the roller body 11. Also, the outer profile of the roller can be adjusted by the elastomer layer 12, so that the connecting portion between the hollow members according to the invention is not necessarily required to be smooth. That is, even if a certain step difference is caused in the connecting portion, it is possible to absorb such a difference by forming the elastomer layer 13 on the connecting portion. Furthermore, the surface accuracy required in accordance with the application can be provided by subjecting the surface of the elastomer layer to a working such as cutting, polishing or the like. Inversely, it is possible to use the roller as a driving roller, a driven roller or the like by roughening the surface of the elastomer layer. Therefore, the electrical conductive roller according to the invention can be used as any roller members used in the imaging apparatus and the application range thereof is wide.

1. An electrical conductive roller comprising a roller body mainly made from a resin material and an electrically conducting agent and an elastomer layer supported on an outer periphery of the roller body, in which the roller body is constructed with a plurality of hollow members connected to each other in a longitudinal direction thereof and is provided with a bonding means for keeping the connection of the hollow members even under a release of a compression force in the longitudinal direction.

2. An electrical conductive roller according to claim 1, wherein the roller is provided with a shaft passing through the roller body in the longitudinal direction.

3. An electrical conductive roller according to claim 1, wherein the roller has a crown form increasing a diameter from each end portion toward a central portion in the longitudinal direction thereof.

4. An electrical conductive roller according to claim 2, wherein the roller has a crown form increasing a diameter from each end portion toward a central portion in the longitudinal direction thereof.
